(19) United States
(12) Patent Application Publication
(10) Pub. No.: US 2012/0124734 A1
(43) Pub. Date: May 24, 2012

(54) Spa assembly

(76) Inventor: Vincent W.S. Lau, Hong Kong (HK)

(21) Appl. No.: 12/927,792

(22) Filed: Nov. 23, 2010

(51) Int. Cl. E04H 4/00; B23P 17/04

(52) U.S. Cl. 4/506; 29/428

(57) ABSTRACT

A spa assembly has a pool assembly having an enclosing body defining an interior, the body made of a soft material and further including a drain pipe, an air inlet, a water inlet and a water outlet provided in the body. The spa assembly also includes a framework assembly having a plurality of beams, legs, and fittings that connect the beams and the legs together, with the beams and the legs positioned outside the enclosing body. The spa assembly also includes a wall assembly having a plurality of vertical wall supports, and a plurality of horizontally-oriented wall panels that are coupled to the plurality of vertical wall supports, with the wall supports and wall panels positioned outside the framework assembly.

### BACKGROUND OF THE INVENTION

1. Field of the Invention

The present invention relates to spa assemblies, and in particular, to a portable spa pool that can be conveniently assembled and dis-assembled to be moved from one location to another.

2. Description of the Prior Art

Spa pools have become increasingly popular as people have come to recognize and enjoy the relaxing and healthy benefits accorded by a good invigorating soak in a spa pool or tub. Most conventional spa pools are provided in the form of a spa tub in a bathroom or a health club, or in the form of an outdoor spa. Each of these spa pools has a jet nozzle system having a plurality of nozzles that must be powered by a pump and its associated plumbing (e.g., tubing that connects the nozzles). Some spa pools are also provided with a heater that works in conjunction with the pump to heat the water that is re-circulated in the spa pool.

Unfortunately, in order to move a conventional spa pool to a different location, the entire spa pool and its accompanying jet nozzle system, pump, plumbing and heater must be completely dis-assembled and moved. Such dis-assembly can be quite complex, and often requires the expertise of a plumber. Even if a normal user is able to accomplish the dis-assembly on his or her own, such dis-assembly is very time-consuming and difficult, and any subsequent re-assembly will be equally time-consuming and challenging. In other words, conventional spa pools tend to stay fixed in their original locations, and are unlikely to be moved to a different location.

Such lack of portability is a significant drawback, since nowadays people are more mobile and often enjoy travelling and moving about. It would be desirable if they could also enjoy the luxury and benefit of the spa pool at different locales while not experiencing the inconveniences and difficulties associated with having to assemble and dis-assemble a conventional spa pool. This would encourage and promote increased use of spa pools.

To meet this demand, attempts have been made to provide portable spa pools that can be easily assembled and disassembled. Unfortunately, the plumbing systems for these portable spa pools can still be rather complex. For example, the nozzles need to be fluidly connected to each other (and to a pump) by tubing so that water can be circulated through these nozzles during use. Unfortunately, connecting a plurality of nozzle together can be a rather complicated task, and if not done correctly, can result in leaks and possible malfunction of the plumbing system.

Thus, there remains a need for a portable spa pool that overcomes the problems associated with the conventional spa pools, which can be assembled and dis-assembled for storage in a quick and convenient manner, and which can be packed and moved about conveniently.

### SUMMARY OF THE DISCLOSURE

It is an objective of the present invention to provide a portable spa pool which can be assembled and dis-assembled for storage in a quick and convenient manner, and which can be packed and moved about conveniently.

It is another objective of the present invention to provide a portable spa pool that has a simple construction that minimizes potential leakage.

The objectives of the present invention are accomplished by providing a spa assembly having a pool assembly having an enclosing body defining an interior, the body made of a soft material and further including a drain pipe, an air inlet, a water inlet and a water outlet provided in the body. The spa assembly also includes a framework assembly having a plurality of beams, legs, and fittings that connect the beams and the legs together, with the beams and the legs positioned outside the enclosing body. The spa assembly also includes a wall assembly having a plurality of vertical wall supports, and a plurality of horizontally-oriented wall panels that are coupled to the plurality of vertical wall supports, with the wall supports and wall panels positioned outside the framework assembly.

### BRIEF DESCRIPTION OF THE DRAWINGS

FIG. 1 is an exploded perspective view of a spa assembly according to one embodiment of the present invention.

FIG. 2 is a perspective view of a connecting pin for the spa assembly of FIG. 1.

FIG. 3 is a perspective view of a metal beam for the spa assembly of FIG. 1.

FIG. 4 is a perspective view of a metal leg for the spa assembly of FIG. 1.

FIG. 5 is a perspective view of a T-fitting for the spa assembly of FIG. 1.

FIG. 6 is a perspective view of a T-fitting top cap for the spa assembly of FIG.

FIG. 7 is a perspective view of a leg cap for the spa assembly of FIG. 1.

FIG. 8A is a perspective view of a wall panel for the spa assembly of FIG. 1.

FIG. 8B is an enlarged perspective view of an end cap of the wall panel of FIG. 8A.

FIG. 9 is a perspective view of a wall support for the spa assembly of FIG. 1.

FIG. 10 is an exploded view illustrating how a metal beam is connected to a T-fitting.

FIG. 11 is a sectional perspective view illustrating how a wall support is connected to the spa assembly of FIG. 1.

FIGS. 12A-12B illustrate how a wall panel is connected to a wall support.

FIG. 12C is a end view of two wall panels shown with their end caps removed and stacked on top of each other.

FIG. 13 illustrates the final assembly of the spa assembly of FIG. 1.

FIG. 14 is a cross-sectional view illustrating the connection of the T-fitting top cap to the wall support and the metal leg.

FIG. 15 illustrates a carrying case that can be used to store all the components in FIG. 1.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices and mechanisms are omitted so as to not obscure the description of the present invention with unnecessary detail.

The present invention provides a spa assembly that can be easily and quickly assembled and dis-assembled without the need for any special tools. Other benefits and features will be described in connection with the spa pool hereinbelow.

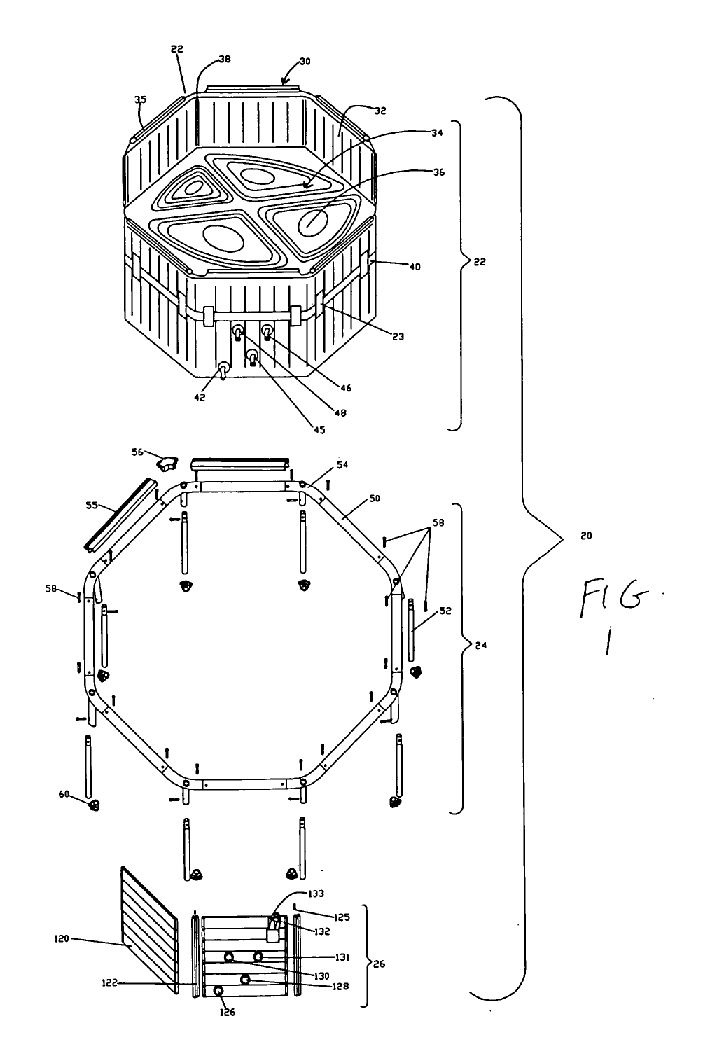

Referring to FIG. 1, the present invention provides a spa assembly 20 that includes a pool assembly 22, a framework assembly 24 and a wall assembly 26. Each of these assemblies include different components that can be easily and conveniently assembled (or taken apart) by a user.

The pool assembly 22 includes a body 30 that is made of a soft, flexible, air-tight material, such as PVC. The material allows the body 30 be inflatable. The body 30 is divided into a plurality of inflatable body sections 32 that extend in a ring-like manner, and together with a planar floor 36, define an enclosed space 34. The floor 36 can be made from the same material as the body 30. A sleeve 35 is provided at the top of each body section 32. The body sections 32 are separated by fold lines 38 about which the body sections 32 can be folded for storage. A belt 40 extends around the exterior surface of the body sections 32 to encircle and support the body sections 32 in an upright orientation. Guides 23 (which can be a piece of PVC welded to the body section 32) are provided for holding the belt 40. A drain pipe 42, an air inlet 45, a water inlet 48 and a water outlet 46 can all be provided at one of the body sections 32. In use, one or more users are seated inside the space 34 and on the floor 36.

The framework assembly 24 includes the following components: a plurality of metal beams 50, a plurality of metal legs 52, a plurality of T-fittings 54 that function to connect the beams 50 and legs 52, a plurality of wall top covers 55 for covering the beams 50, a plurality of T-fitting top caps 56 for covering the T-fittings 54, a plurality of connecting pins 58, and a plurality of leg caps 60.

Referring to FIG. 2, the connecting pin 58 is made of plastic and has a head 62, a shaft 64, and an end that has two enlarged resilient legs 66 with a gap 68 therebetween. Such an arrangement allows the legs 66 to be pressed inwardly to allow them to fit through openings (e.g., 70, 80) and then secure the pin 58 at the openings, as explained below.

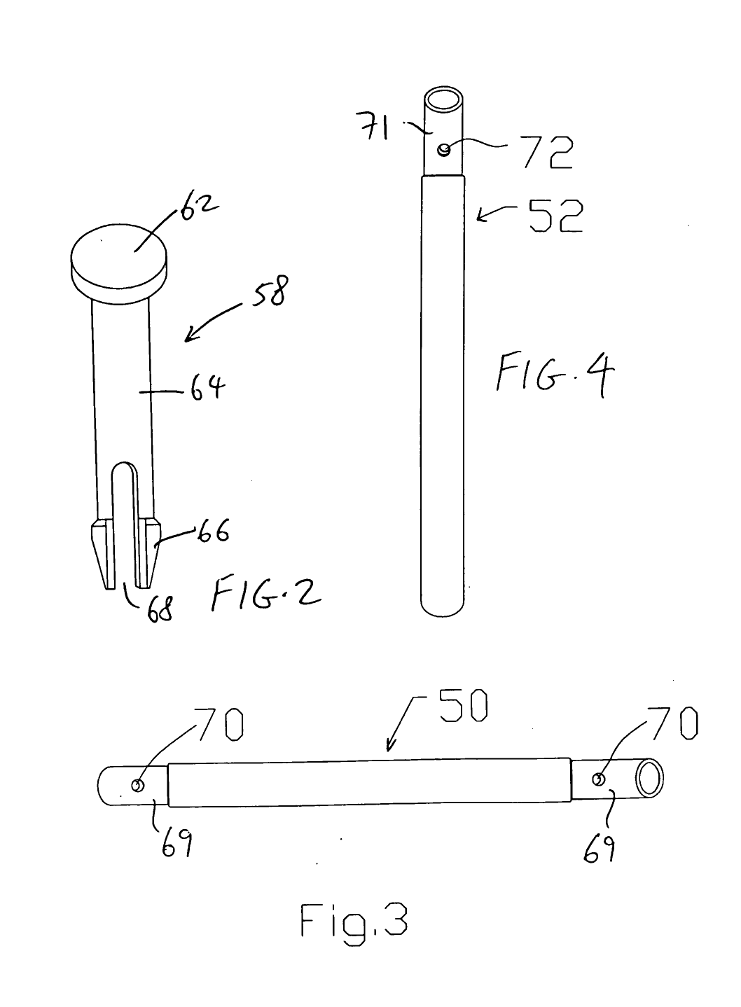

Referring to FIG. 3, the metal beam 50 is essentially a cylindrical tube having two opposing end segments 69 that have a slightly smaller diameter than the cylindrical tube itself. A set of aligned openings 70 is provided at each end segment 69. Similarly, referring to FIG. 4, the metal leg 52 is also a cylindrical tube but has only one upper end segment 71, with one set of aligned openings 72 at its upper end segment 71.

Referring to FIG. 5, the T-fitting 54 has two horizontal cylindrical tube sections 74 and 76 that are bent at an angle to each other, and a vertical cylindrical tube section 78 that extends from the bend or connection between the tube sections 74, 76, and perpendicular to the tube sections 74, 76. The tube section 78 extends to an upper section 75. An aligned set of openings 80 is provided adjacent the end of each tube section 74, 76, and another aligned set of openings 81 is provided adjacent the bottom end of the tube section 78.

As shown in FIG. 1, the wall top cover 55 is a generally elongated inverted U-shaped piece of material that is preferably made of plastic or other heat-resistant material.

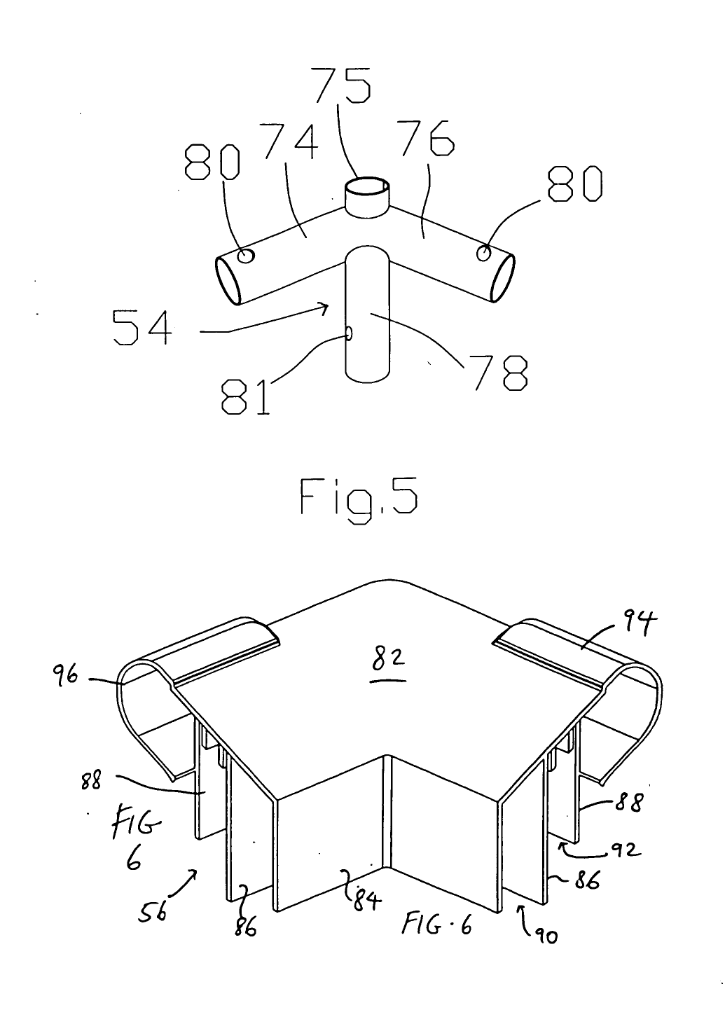

Referring to FIG. 6, the T-fitting top cap 56 has angled top plate 82 with three angled walls 84, 86 and 88 extending vertically downwardly. These walls 84, 86, 88 define a first angled gap 90 between the walls 84 and 86, and a second angled gap 92 between the walls 86 and 88. Curved pieces 94 and 96 extend from opposite ends of the top plate 82.

Referring to FIG. 7, the leg cap 60 has a base plate 100 that is shaped like a slice of a pie, having two straight sides 102, 104 connected by a wider outer angled side 106 and a smaller inner curved side 108. A pair of parallel ridges 110, 112 are provided adjacent the angled side 106, defining an angled slot 114 therebetween, and a circular recess 116 is provided adjacent the curved side 108.

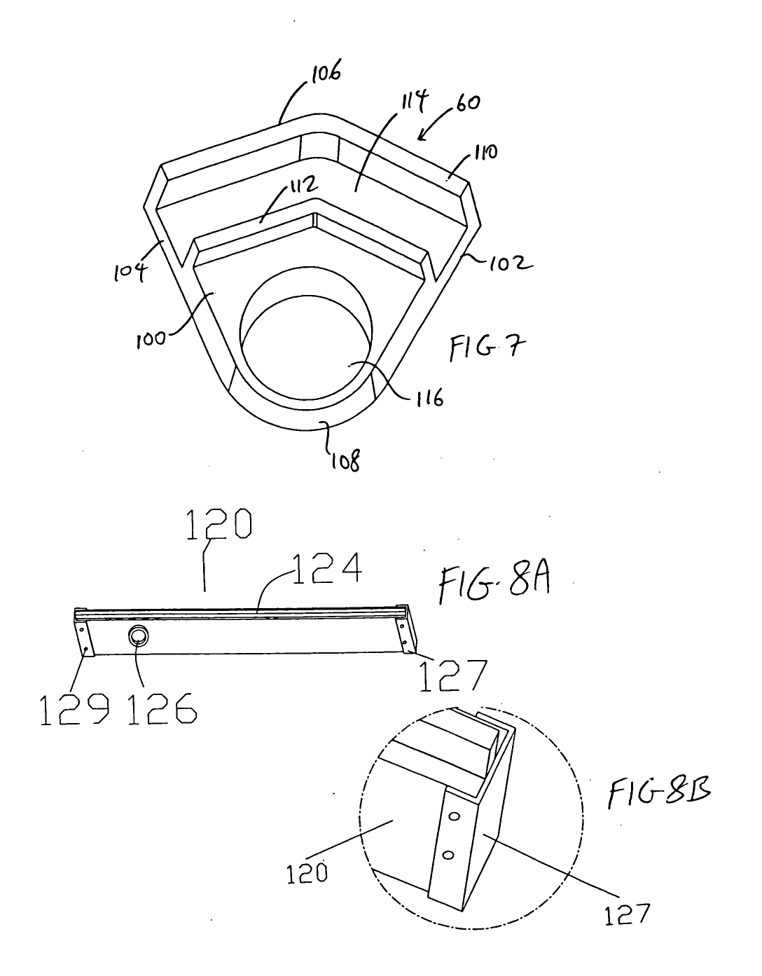

The wall assembly 26 includes a plurality of horizontally-oriented side wall panels 120 and a plurality of vertically-oriented side wall supports 122. FIG. 8 shows a generic side wall panel 120 that has an opening 126. The wall panel 120 is a plastic piece of material, and most of the wall panels 120 do not have an opening. At each end of each wall panel 120 is provided an end cap 127 to protect the panel 120. The end cap 127 also functions to maintain the panel 120 securely on the wall supports 122 (as explained below). Since the panels 120 are formed by extrusion, it is not possible to extrude the panels 120 to have two extended edges. Therefore, end caps 127 are secured (e.g., by locking pins 129) so that when the spa pool is filled with water, the water pressure will push the wall panels 120 outwardly. If there are no end caps 127, the panels 120 will be separate from the vertical supports 122. A horizontal tongue 124 extends from a horizontal edge of the wall panel 120. FIG. 8 shows a wall panel 120 that has a drain outlet opening 126. Other wall panels 120 can be provided with no openings, an air hose inlet opening 128, or water hose inlet opening 130 and water hose outlet opening 131 (see FIG. 1). Another wall panel 120 can be provided with an air hose U-tube bracket 132.

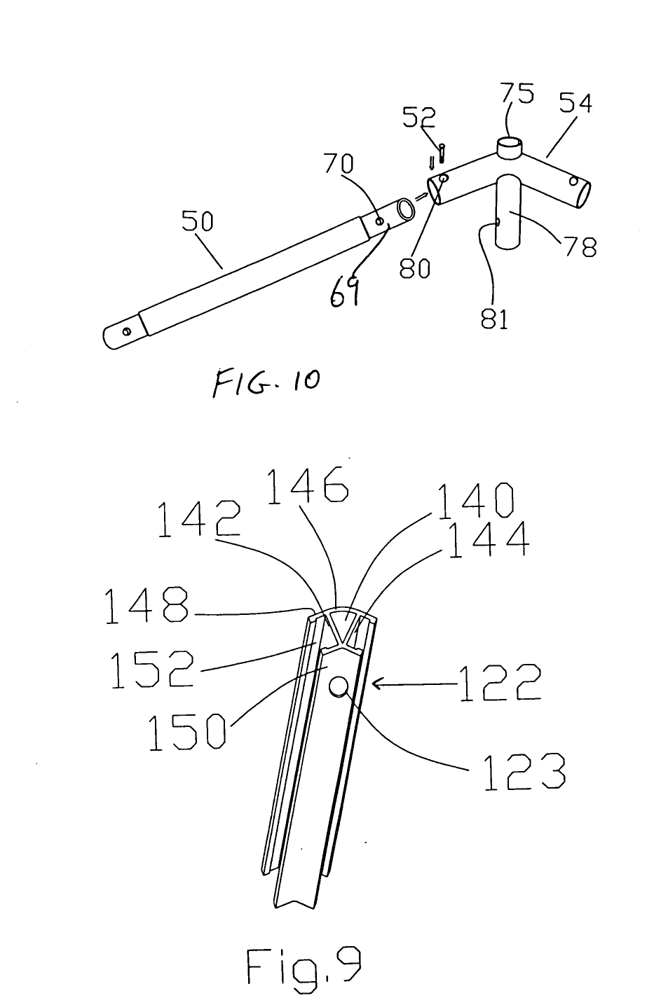

Referring to FIG. 9, each wall support 122 has a core section 140 that is shaped similarly to the base plate 100 of the leg cap 60 in that it has two straight sides 142, 144 connected by a wider outer angled side 146. A pair of parallel outer wings 148, 150 extend from either side of the core section 140, with a gap 152 defined between the wings 148, 150 on either side of the core section 140. The core section 140 and the wings 148, 150 extend in an elongated manner along the vertical side wall support 122. Aligned openings 123 are provided on the wall of the wings 148, 150.

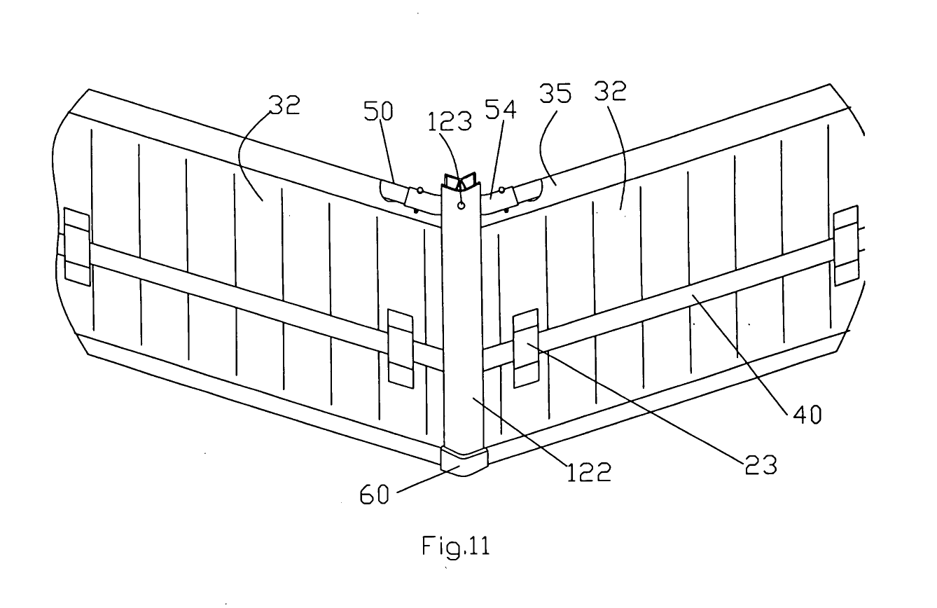

FIGS. 10-13 illustrate how the spa assembly 20 can be assembled. In the first step, the body 30 and the planar floor 36 of the pool assembly 22 is inflated.

Next, the metal beams 50 are connected. First, a metal beam 50 is inserted into the sleeve 35 of each body section 32. The metal beams 50 in the respective sleeves 35 are then connected by T-fittings 54. Referring to FIG. 10, each end segment 69 of each metal beam 50 is inserted into an open end of a cylindrical tube section 74 or 76 of a T-fitting 54 so that the outer surfaces of the tube sections 74, 76 are flush with the outer surface of the beams 50, and the openings 70 and 80 on the metal beam 50 and tube section 74/76, respectively, are aligned so that a connecting pin 58 can be inserted through the aligned openings 70 and 80 to secure the end segment 69 of the metal beam 50 to a tube section 74 or 76. This is repeated around the periphery of the spa assembly 20 so that all the metal beams 50 are connected to each other by T-fittings 54 to form a ring of connected metal beams 50.

In the next step, the metal legs 52 are connected. Each metal leg 52 is slid through a belt 40 (see FIG. 1) provided on the exterior surface of each fold line 38, and the end segment 71 of each metal leg 52 with the opening 72 is inserted into the open end of the vertical tube section 78 of a T-fitting 54, and the openings 72 and 81 on the metal leg 52 and tube section 78, respectively, are aligned so that a connecting pin 58 can be inserted through the aligned openings 72 and 81 to secure the end segment 71 of the metal leg 52 to a tube section 78. This is repeated around the periphery of the spa assembly 20 so that all the metal legs 52 are connected to a corresponding T-fitting 54. At this point, the bottom of each leg 52 is fitted into a corresponding recess 116 of a corresponding leg cap 60.

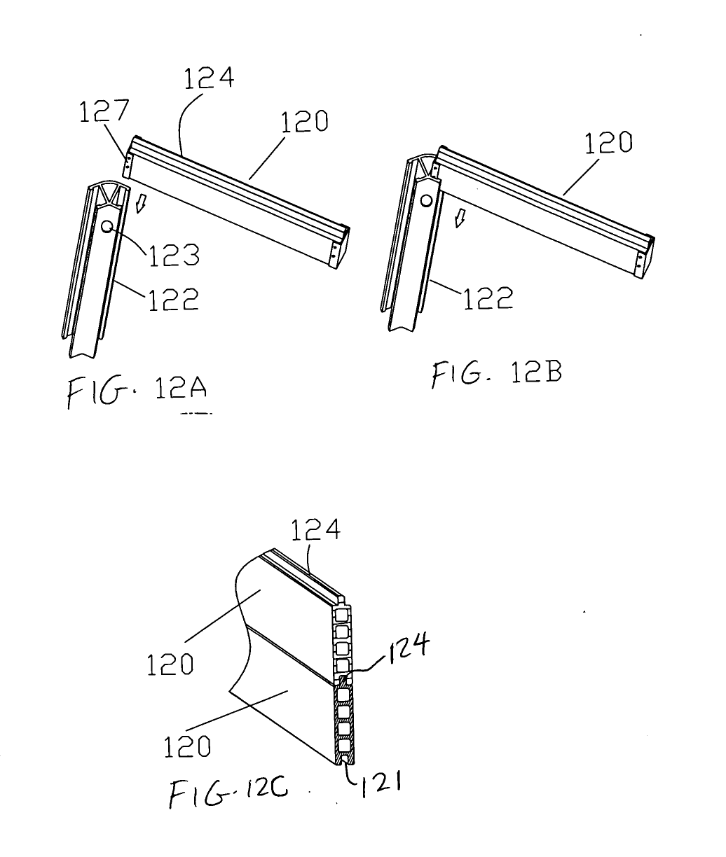

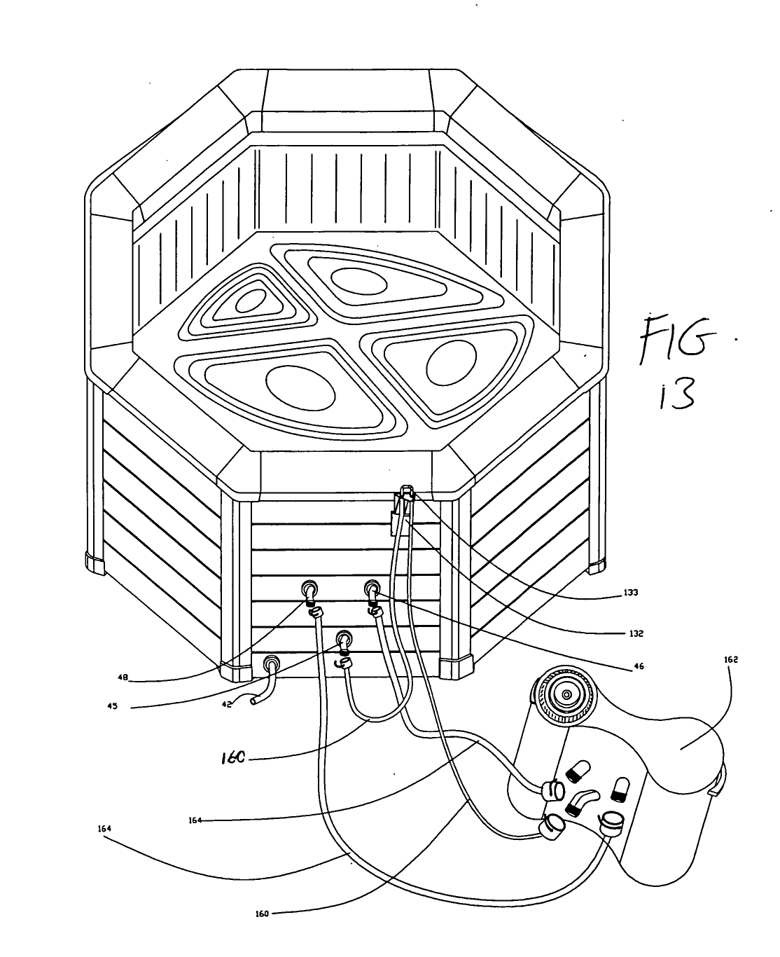

Next, the wall assembly 26 is assembled. First, each wall support 122 is fitted into the slot 114 of a corresponding leg cap 60 (see FIG. 11). Now, the wall panels 120 can be installed. Referring to FIGS. 12A-12B, each wall panel 120 is slid into the opposing wall supports 122 by sliding an end cap 127 into the gap 152 of the wall support 122. The wall panel 120 is slid downwardly with the tongue 124 facing upwardly. After the first wall panel 120 is slid to the bottom of the wall supports 122, the next wall panel 120 is slid down the same set of opposing wall supports 122, and the upwardly-facing tongue 124 of the lower panel 120 is fitted into a lower groove 121 of the upper panel 120 (see FIG. 12C). This is repeated until the entire body section 32 is covered by wall panels 120. In one embodiment, seven wall panels 120 are slid between two wall supports 122 to cover a body section 32. This process is repeated until all the body sections 32 are covered by wall panels 120.

When installing these wall panels 120, written instructions can be provided to the user to guide the user in locating certain wall panels 120 at certain locations. For example, as shown in FIGS. 1 and 13, it may be desirable for the wall panels 120 containing the openings 126, 128, 130 to be positioned at certain locations. Specifically, it is desirable for these openings 126, 128 and 130, as well as the bracket 132, to be positioned along the same body section 32. These openings 126, 128, 130 can be also be aligned with hoses and tubes extending from the body section 32.

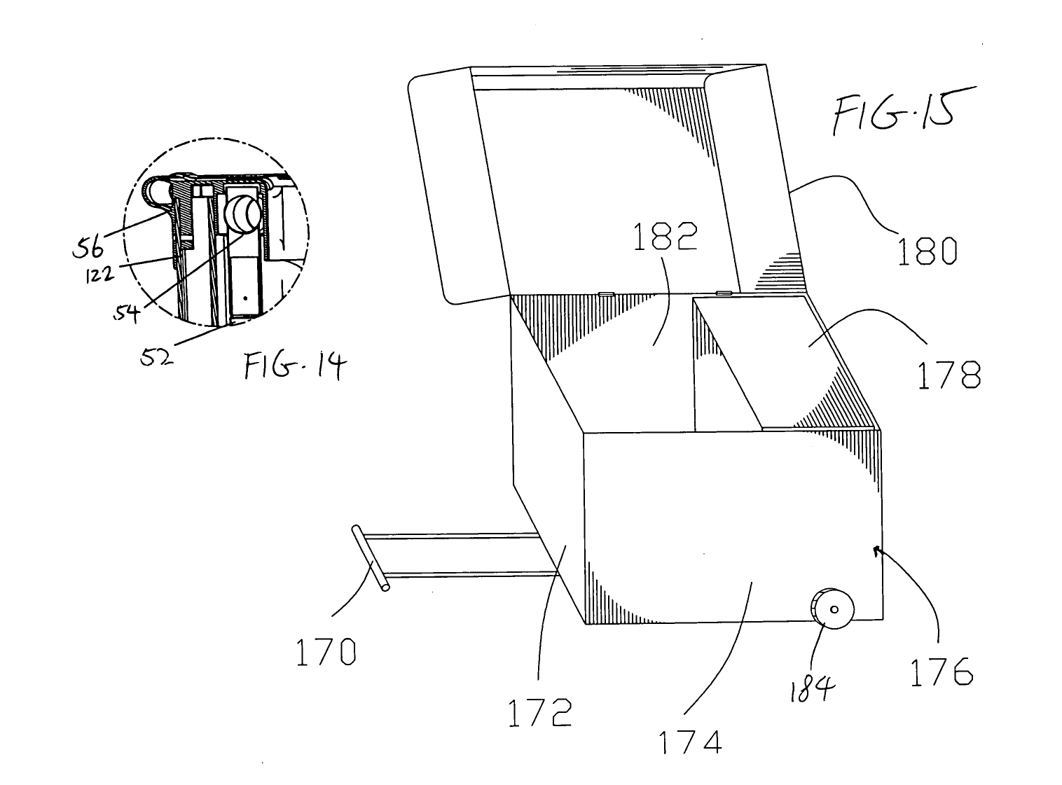

Finally, the wall assembly 26 is completed by installing the T-fitting top caps 56 and the wall top covers 55. In particular, the T-fitting top caps 56 are press-fitted or snap-fitted over the wall supports 122 and the T-fittings 54 such that the wall supports 122 are fitted into the gap 92 of the T-fitting top cap 56, and the T-fittings 54 are fitted into the gap 90 of the T-fitting top cap 56. See FIG. 14. The top covers 55 are fitted over the metal beams 50. A connecting pin (not shown) is then inserted through an opening (not shown) in the wall 88 of each T-fitting top cap 56 and the openings 123 in the corresponding wall support 122 to prevent the T-fitting top cap 56 from being unintentionally removed.

In the final step, the hoses are connected. Referring to FIGS. 1 and 13, an air hose 160 is connected to the air hose opening 128 and to a spa pump 162. The air hose 160 can be secured on the U-tube 133 at the bracket 132. The water hose 164 is then connected to the spa pump 162 and the water hose inlet 48 and outlet openings 46.

The spa assembly 20 is now ready for use. The spa assembly 20 can be easily dis-assembled by removing the various components in the reverse order from that which was described above. A cover (not shown) can be placed over the spa assembly 20 when it is in its assembled state, but when it is not in use. Assembly and dis-assembly of the spa assembly 20 can be performed conveniently and quickly, thereby allowing the user to store and transport the spa assembly 20 in its dis-assembled state.

The construction of the spa assembly 20 provides a soft body 30 that is comfortable for the user to sit on, while providing a cushioning effect so that the user will not contact the metal legs 52 and the metal beams 50. The construction of the wall assembly 26 and the framework assembly 24 provides a boundary where the force of the water inside the body 30 is transferred to the metal framework of the metal beams 50 and metal legs 52, and prevents the spa assembly 20 from bulging out like an inflatable pool when the spa assembly 20 is filled with water.

FIG. 15 illustrates a carrying case 176 that can be used to store all the components of the spa assembly 20. The case 176 can have a plurality of side walls 172, 174, 182, with a lid 180, a handle 170, and rollers 184. Compartments 178 can be provided inside the case 176 to allow the components of the spa assembly 20 to be stored in an organized and convenient manner.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A spa assembly, comprising:
a pool assembly having an enclosing body defining an interior, the body made of a soft material, further including a drain pipe, an air inlet, a water inlet and a water outlet provided in the body;
a framework assembly having a plurality of beams, legs, and fittings that connect the beams and the legs together, with the beams and the legs positioned outside the enclosing body; and
a wall assembly having a plurality of vertical wall supports, and a plurality of horizontally-oriented wall panels that are coupled to the plurality of vertical wall supports, with the wall supports and wall panels positioned outside the framework assembly.

2. The assembly of claim 1, wherein the body includes a plurality of inflatable body sections separated by fold lines.

3. The assembly of claim 1, wherein the body includes a belt that surrounds the exterior of the body, with each leg received between the belt and the body.

4. The assembly of claim 1, further including fitting top caps, with each fitting top cap secured to one leg and a fitting.

5. The assembly of claim 1, wherein each wall panel has an end cap provided at opposite ends, and each wall support has two vertically-extending gaps, with each end cap slidably fitted inside a vertically-extending gap.

6. The assembly of claim 1, further including a spa pump coupled to the air inlet, the water inlet and the water outlet.

7. The assembly of claim 1, wherein at least one wall panel is provided with openings that are aligned with the air inlet, the water inlet and the water outlet.

8. The assembly of claim 1, wherein each fitting has two horizontal tube sections and a vertical tube section, with each horizontal tube section receiving an end of a beam, and each vertical tube section receiving an upper end of a leg.

9. The assembly of claim 1, further including a plurality of leg caps, each having a recess that receives a lower end of one of the legs, and a slot that receives a lower end of one of the wall supports.

10. A method of deploying a spa assembly, comprising:
a. providing a spa assembly having:
a pool assembly having an enclosing body defining an interior, the body made of a soft material, further including a drain pipe, an air inlet, a water inlet and a water outlet provided in the body, the body also having a belt that surrounds the body;
a framework assembly having a plurality of beams, legs, fittings, and leg caps; and
a wall assembly having a plurality of vertical wall supports, and a plurality of horizontally-oriented wall panels;
b. forming the framework assembly by coupling the beams and the legs to respective fittings;
c. extending each leg between the belt and the body;
d. fitting a lower end of each leg into a recess on a respective leg cap;
e. fitting a lower end of each wall support into a slot on a respective leg cap; and
f. coupling the wall panels to the wall supports by sliding each wall panel between adjacent pairs wall supports.

11. The method of claim 10, further including:
g. securing a plurality of fitting top caps, with each fitting top cap secured to one leg and a fitting.

12. The method of claim 10, wherein each fitting has two horizontal tube sections and a vertical tube section, wherein step (b) further comprises:
(b1) securing an end of each beam to a horizontal tube section of a fitting; and
(b2) securing an upper end of a leg to each vertical tube section.

13. The method of claim 10, further including:
positioning the beams and the legs outside the body; and
positioning the wall panels outside the beams and the legs.
